SEQUENCE LISTING (51 sequences)

SEQ ID NO: 1 - DNA, 17 bp, Influenza A virus
agatgagtcttctaacc

SEQ ID NO: 2 - DNA, 17 bp, Artificial
  synthetic oligonucleotide based on SEQ ID NO1
agttgagtcttctaacc

SEQ ID NO: 3 - DNA, 17 bp, Artificial
  synthetic oligonucleotide based on SEQ ID NO1
agatgtgtcttctaacc

SEQ ID NO: 4 - DNA, 17 bp, Artificial
  synthetic oligonucleotide based on SEQ ID NO1
agatgggtcttctaacc

SEQ ID NO: 5 - DNA, 17 bp, Artificial
  synthetic oligonucleotide based on SEQ ID NO1
agatgcgtcttctaacc

SEQ ID NO: 6 - DNA, 17 bp, Artificial
  synthetic oligonucleotide based on SEQ ID NO1
agatgaatcttctaacc

SEQ ID NO: 7 - DNA, 17 bp, Artificial
  synthetic oligonucleotide based on SEQ ID NO1
agatgagtattctaacc

SEQ ID NO: 8 - DNA, 17 bp, Artificial
  synthetic oligonucleotide based on SEQ ID NO1
agatgagtctgctaacc

SEQ ID NO: 9 - DNA, 17 bp, Artificial
  synthetic oligonucleotide based on SEQ ID NO1
agatgagtctcctaacc

SEQ ID NO: 10 - DNA, 17 bp, Artificial
  synthetic oligonucleotide based on SEQ ID NO1
agatgagtcttataacc

SEQ ID NO: 11 - DNA, 17 bp, Artificial
  synthetic oligonucleotide based on SEQ ID NO1
agatgagtcttcttacc

SEQ ID NO: 12 - DNA, 17 bp, Artificial
  synthetic oligonucleotide based on SEQ ID NO1
agatgagtcttctatcc

SEQ ID NO: 13 - DNA, 17 bp, Artificial
  synthetic oligonucleotide based on SEQ ID NO1
agatgagtcttctaccc

SEQ ID NO: 14 - DNA, 16 bp, Artificial
  binding sequence derived from influenza virus
aatgggggtgcagatg

SEQ ID NO: 15 - DNA, 16 bp, Artificial
  binding sequence derived from influenza virus
cgattcaagtgatcct

SEQ ID NO: 16 - DNA, 16 bp, Artificial
  binding sequence derived from influenza virus
gatgggagtgcaaatg

SEQ ID NO: 17 - DNA, 17 bp, Artificial
  binding sequence derived from influenza virus
gatgcaacgattcaagt

SEQ ID NO: 18 - DNA, 16 bp, Artificial
  binding sequence derived from influenza virus
attgtggattcttgat

SEQ ID NO: 19 - DNA, 16 bp, Artificial
  binding sequence derived from influenza virus
ttgcacttgatattgt

SEQ ID NO: 20 - DNA, 16 bp, Artificial
  binding sequence derived from influenza virus
cctgatattgtggatt

SEQ ID NO: 21 - DNA, 16 bp, Artificial
  binding sequence derived from influenza virus
ttgcacttgatactgt

SEQ ID NO: 22 - DNA, 16 bp, Artificial
  binding sequence derived from influenza virus
acccgcttgctgttgc

SEQ ID NO: 23 - DNA, 16 bp, Artificial
  binding sequence derived from influenza virus
acccgcttgttgttgc

SEQ ID NO: 24 - DNA, 18 bp, Artificial
  binding sequence derived from influenza virus
atcctattgctgttgccg

SEQ ID NO: 25 - DNA, 18 bp, Artificial
  binding sequence derived from influenza virus
atcctattgttgttgccg

SEQ ID NO: 26 - DNA, 18 bp, Artificial
  binding sequence derived from influenza virus
accctcttgctgttgctg

SEQ ID NO: 27 - DNA, 18 bp, Artificial
  binding sequence derived from influenza virus
accctcttgttgttgctg

SEQ ID NO: 28 - DNA, 16 bp, Artificial
  binding sequence derived from influenza virus
atcctctcgctattgc

SEQ ID NO: 29 - DNA, 16 bp, Artificial
  binding sequence derived from influenza virus
atcctctcgttattgc

SEQ ID NO: 30 - DNA, 16 bp, Artificial
  binding sequence derived from influenza virus
atcctctcgctgttgc

SEQ ID NO: 31 - DNA, 16 bp, Artificial
  binding sequence derived from influenza virus
atcctctcgttgttgc

SEQ ID NO: 32 - DNA, 25 bp, Artificial
  binding sequence derived from influenza virus
agtgatcctcttgctgttgccgcaa

SEQ ID NO: 33 - DNA, 25 bp, Artificial
  binding sequence derived from influenza virus
agtgatcctcttgttgttgccgcaa

SEQ ID NO: 34 - DNA, 25 bp, Artificial
  binding sequence derived from influenza virus
atcctattgctgttgccgcaaatat

SEQ ID NO: 35 - DNA, 25 bp, Artificial
  binding sequence derived from influenza virus
atcctattgttgttgccgcaaatat

SEQ ID NO: 36 - DNA, 18 bp, Artificial
  binding sequence derived from influenza virus
ctgcgaatatcattggga

SEQ ID NO: 37 - DNA, 18 bp, Artificial
  binding sequence derived from influenza virus
ctgcgagtatcattggga

SEQ ID NO: 38 - DNA, 22 bp, Artificial
  binding sequence derived from influenza virus
gttgttgccgcgaatataattg

SEQ ID NO: 39 - DNA, 22 bp, Artificial
  binding sequence derived from influenza virus
gttgttgccgcgagtataattg

SEQ ID NO: 40 - DNA, 16 bp, Artificial
  binding sequence derived from influenza virus
gcagcaaatatcattg

SEQ ID NO: 41 - DNA, 16 bp, Artificial
  binding sequence derived from influenza virus
gcagcaagtatcattg

SEQ ID NO: 42 - DNA, 16 bp, Artificial
  binding sequence derived from influenza virus
gccgcaaacatcattg

SEQ ID NO: 43 - DNA, 16 bp, Artificial
  binding sequence derived from influenza virus
gccgcaagcatcattg

SEQ ID NO: 44 - DNA, 21 bp, Artificial
  binding sequence derived from influenza virus
ttattgccgcgaatatcattg

SEQ ID NO: 45 - DNA, 21 bp, Artificial
  binding sequence derived from influenza virus
ttattgccgcgagtatcattg

SEQ ID NO: 46 - DNA, 24 bp, Artificial
  binding sequence derived from influenza virus
ttgttgttgccgcgaatatcattg

SEQ ID NO: 47 - DNA, 24 bp, Artificial
  binding sequence derived from influenza virus
ttgttgttgccgcgagtatcattg

SEQ ID NO: 48 - DNA, 16 bp, Artificial
  binding sequence derived from influenza virus
gccgcaaatatcattg

SEQ ID NO: 49 - DNA, 16 bp, Artificial
  binding sequence derived from influenza virus
gccgcaagtatcattg

SEQ ID NO: 50 - DNA, 24 bp, Artificial
  binding sequence derived from influenza virus
ttgttgctgcgaatatcattggga

SEQ ID NO: 51 - DNA, 24 bp, Artificial
  binding sequence derived from influenza virus
ttgttgctgcgagtatcattggga

(19) United States
(12) Patent Application Publication
(10) Pub. No.: US 2010/0273670 A1
(43) Pub. Date: Oct. 28, 2010

(54) DETECTION OF ANTIVIRAL RESISTANCE IN INFLUENZA A USING DNA MICROARRAY

(76) Inventors: Kathy L. Rowlen, Boulder, CO (US); Robert Kuchta, Boulder, CO (US); Michael Townsend, Atlanta, GA (US); James Smagala, Arvada, CO (US); Erica Dawson, Broomfield, CO (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/438,271

(22) PCT Filed: Aug. 21, 2007
(86) PCT No.: PCT/US07/76431

§ 371 Date: Jul. 9, 2010

Related U.S. Application Data
(60) Provisional application No. 60/823,054, filed on Aug. 21, 2006.

(51) Int. Cl. C40B 30/04; C40B 40/06; C40B 50/14

(52) U.S. Cl. 506/9; 506/16; 506/30

(57) ABSTRACT

Embodiments of the present invention relate to compositions, methods and apparatus for detection of antiviral agent resistance or sensitivity of a virus. In some embodiments, antiviral agent resistance or sensitivity of influenza types, such as A, B and C may be identified. In more embodiments, sub-types such as the hemagglutinin (HA) and neuraminidase (NA) of influenza A may be analyzed for antiviral agent resistance or sensitivity. In a particular embodiment, the various strains of influenza virus may be analyzed for resistance or sensitivity using DNA microarray analysis designed to target a gene segment. In various embodiments, a microarray-based assay system with capture and detection (label) probes may be utilized to identify a change in a gene segment that confers resistance or sensitivity to an antiviral agent of an influenza strain.

### CROSS-REFERENCE TO RELATED APPLICATION

The present application claims the benefit under 35 U.S.C. §119(e) of provisional U.S. patent application Ser. No. 60/823,054, filed on Aug. 21, 2006, which is incorporated herein by reference in its entirety.

### FIELD

Embodiments of the present invention relate to compositions, methods and apparatus for detection of antiviral agent resistance or sensitivity of influenza. In some embodiments, antiviral agent resistance of influenza types, such as A, B and C may be identified. In more embodiments, sub-types such as the hemagglutinin (HA) and neuraminidase (NA) of influenza A may be analyzed for antiviral agent resistance or sensitivity. In a particular embodiment, the various strains of influenza virus may be analyzed for resistance or sensitivity using DNA microarray analysis designed to target a gene segment. In various embodiments, a microarray-based assay system with capture and detection (label) probes may be utilized to identify a change in a gene segment that confers resistance or sensitivity to an antiviral agent of an influenza strain.

### BACKGROUND

Influenza is an orthomyxovirus with three genera, types A, B, and C. The types are distinguished by the nucleoprotein antigenicity. Types A and B are the most clinically significant, causing mild to severe respiratory illness. Influenza B is a human virus and does not appear to be present in an animal reservoir. Type A viruses exist in both human and animal populations, with significant avian and swine reservoirs. Influenza A and B each contain 8 segments of negative sense ssRNA. Type A viruses can also be divided into antigenic sub-types on the basis of two viral surface glycoproteins, hemagglutinin (HA) and neuraminidase (NA). There are currently 15 identified HA sub-types (designated H1 through H15) and 9 NA sub-types (N1 through N9) all of which can be found in wild aquatic birds. Of the 135 possible combinations of HA and NA, only four (H1N1, H1N2, H2N2, and H3N2) have widely circulated in the human population since the virus was first isolated in 1933. The two most common sub-types of influenza A currently circulating in the human population are H3N2 and H1N1.

New type A strains emerge due to genetic drift that results in slight changes in the antigenic sites on the surface of the virus. Thus, the human population experiences epidemics of “the flu” each year. However, more drastic genetic changes can result in an antigenic shift (a change in the subtype of HA and/or NA) resulting in a new subtype capable of rapidly spreading in a susceptible population. The influenza A virus of 1918 was of the H1N1 subtype and it replaced the previous virus (probably H3N8 as deduced by seroarcheology) that had been the dominant type A virus in the human population. Antigenic shift most likely arises from genetic reassortment when two different sub-types infect the same cell. Since the viral genetic information is stored in eight separate segments, packaging of new virions within a cell that is replicating two different viruses (e.g. an avian type A and a human type A) can result in a virus with a mixture of genes from each of the parent viruses. This is presumed to be the mechanism by which avian-like surface glycoproteins (and some internal, nonglycoprotein genes) appeared in the viruses responsible for the 1957 (H2N2) and 1968 (H3N2) pandemics. This reassortment of surface antigens is an ongoing possibility as shown by the recent appearance of H1N2 reassortants worldwide.

Subtypes are sufficiently different as to make them non-crossreactive with respect to antigenic behavior; prior infection with one subtype (e.g. H1N1) leads to no immunity to another (e.g. H3N2). It is this lack of crossreactivity that allows a novel subtype to become pandemic as it spreads through an immunologically naïve population. In the case of populations in close contact, such as military personnel, students, factory workers, etc., spread is especially rapid. Consequently, the appearance of a new subtype (or the reappearance of a previously circulating strain) can have significant consequences for public health in general and defense preparedness in particular. Rapid identification of a novel subtype not covered by the current vaccine would allow prophylactic antiviral agents to be administered to reduce its impact.

Although relatively uncommon, it is possible for nonhuman influenza A strains to jump directly from their “natural” reservoir to humans. The highly lethal Hong Kong avian influenza outbreak in humans in 1997 was due to an influenza A H5N1 virus that was an epidemic in the local poultry population at that time. This virus killed six of the 18 patients shown to have been infected. Fortunately, this highly pathogenic avian virus, which rapidly spread in the avian population, was not effectively transmitted from one human to another since infection appeared to require direct exposure to infected poultry.

Annual influenza A virus infections have a significant impact on humanity both in terms of death (between 500,000 and 1,000,000 worldwide each year) and economic impact resulting from direct and indirect loss of productivity during infection. Of even greater concern is the ability of influenza A viruses to undergo natural and engineered genetic change that could result in the appearance of a virus capable of rapid and lethal spread within the population.

Current public and scientific concern over the possible emergence of a pandemic strain of influenza or other pathogenic or non-pathogenic viruses requires earlier diagnosis and more effective treatments of these viruses. A need exists for identifying sensitivity or resistance of these viruses to current and developing therapies particularly for influenza A virus to control viral impact on human, avian and animal health within the U.S. and worldwide.

### SUMMARY

The present invention provides for methods, compositions and apparatus for rapidly identifying viral sensitivity or resistance to an agent. In one particular embodiment, an apparatus or method of the present invention can identify influenza virus sensitivity or resistance to an agent. In accordance with this embodiment, the agent can be an antiviral agent including, but not limited to, adamantane inhibitors; amantadine and rimantadine, and neuraminidase inhibitors; zanamivir, oseltamivir and a prodrug A-315675, Peramivir, as well as other antiviral agents and a combination thereof. In another embodiment, the analysis can identify an influenza virus that is sensitive or resistant to an antiviral agent by using an array technology.

Test samples herein may be any type of sample, such as an individual's sample, or a culture sample containing or suspected of containing a virus, including but not limited to laboratory cultures, nasopharangeal washes, expectorate, respiratory tract swabs, throat swabs, tracheal aspirates, bronchoalveolar lavage, mucus and saliva. In one embodiment, a sample contemplated for testing may include any mammal known to harbor influenza, including but not limited to humans, birds, horses, dogs, cats and swine.

Certain embodiments may concern an apparatus of use for influenza or another virus, such as an “AVRChip™” apparatus (where AVR denotes a target “antiviral resistance” conferring gene to an agent). In a more particular embodiment, an AVRChip™ apparatus may include an array with one or more attached capture probes designed to bind to the influenza matrix (M) gene segment sequences conferring sensitivity or resistance to an antiviral agent. In a particular embodiment, an AVRChip™ apparatus may include two hundred or less of such sequences. In a more particular embodiment, an AVRChip™apparatus may include 50 or less of such sequences directed at a single gene locus. In accordance with this embodiment, a single gene locus may be the M gene segment of influenza A. The capture probes attached to an AVRChip™ apparatus may be designed to hybridize with nucleic acid sequences from 1 or more regions of a gene locus. In a more particular embodiment, the capture probes attached to an AVRChip™ apparatus may be designed to hybridize with nucleic acid sequences from a single region of a gene locus of a virus such as influenza virus.

Other embodiments may include isolated nucleic acids of a viral organism for analysis of sensitivity or resistance to an agent. The isolated nucleic acids may be capture probes, target sequences for detection, primers for amplification of target sequences and/or labeled tag sequences for optical detection of bound target sequences. In alternative embodiments, any other non-optical method of detection known in the art may be utilized with appropriately tagged labels.

Still other embodiments may include methods for analysis of sensitivity or resistance to an agent of influenza virus types, subtypes and/or strains. Such methods may include designing and/or obtaining an AVRChip™ apparatus and obtaining one or more samples from one or more subjects suspected of having an influenza infection, amplifying target sequences directed toward a single gene in the samples, hybridizing the target sequences to capture probes on the an AVRChip™ apparatus, and detecting the presence of bound target sequences on the AVRChip™ apparatus. Detection may include hybridizing labeled tag sequences to the bound target sequences. In preferred embodiments, the target sequences to be detected are viral RNA of the one or more target genes. The viral RNA may be amplified, for example by reverse transcription followed by PCR, and/or subsequent run-off transcription using the PCR product as a template. In alternative embodiments, viral cDNA may be used as a target sequence.

The skilled artisan will realize that although the methods, compositions and apparatus are described in terms of particular embodiments for application with influenza virus, they are also of use with other types of viral detection and/or diagnosis. Other types of viruses contemplated herein include, but are not limited to, HIV-RNA virus like influenza, herpes viruses, for example, Herpes Simplex Viruses such as herpes simplex virus 1 and herpes simplex virus 2, cytomegalovirus, and varicella zoster, other DNA viruses, Hepatitis C-RNA virus, Hepatitis B-DNA virus HIV, and vaccinia virus. Methods and apparati disclosed herein may also be of use with resistance to novel antiviral agents for emerging viruses such as the SARS, coronavirus, and others. In addition, methods and apparati disclosed herein, can also be contemplated of use for detection of antibiotic resistance in bacteria. A large number of bacteria contain mutations which can be detected. This list includes, but is not limited to, Methicillin-resistant Staphylococcus aureus and multi-drug resistant Mycobacterium tuberculosis have been found to contain point mutations associated with drug resistance. Therefore, arrays may be used to identify antibiotic resistant and antibiotic sensitive bacteria in a sample.

### BRIEF DESCRIPTION OF THE DRAWINGS

The following drawings form part of the present specification and are included to further demonstrate certain embodiments of the present invention. The embodiments may be better understood by reference to one or more of these drawings in combination with the detailed description of specific embodiments presented herein.

FIG. 1. represents an exemplary schematic for use of a match/mismatch for detection of antiviral resistance. A) Viral RNA from a sensitive virus (striped) strongly hybridizes to the sensitive specific sequence but this is reduced for the resistant specific sequence. In this exemplary method, both capture sequences are identical except for the one position designed to probe resistance. B) The reverse scenario where a resistant virus RNA (solid) hybridizes to the same sequences.

FIG. 2. represents an exemplary schematic illustrating a location used for selection of capture and label sequences of the M gene. The grey diamonds from 754-788 and 816-849 were use for selection of label sequences. The black triangles (bottom) region from 780-816 was used for selection of capture sequences. Nucleotides highlighted as grey circles cause amino acid changes resulting in resistance. Mutations for V27A and S31N resistance, which were chosen for testing on the AVR array are designated by the arrows

FIG. 3. represents an example of an AVR (antiviral resistance) array Layout. Individual capture sequences were spotted in triplicate next to positive control (hybridization control) spots, which provide orientation when viewing the array. The numbering denotes different sequences spotted for resistance detection that include 7 oligos to query the 793 position and 8 to query the 805 position.

FIG. 4. represents an exemplary method of mismatch discrimination using established FluChip™ hybridization conditions. The mean signal/background for each oligo was normalized to the intensity with the perfect matched oligo A-MP-24C. This intensity is plotted as a function of the position of the mismatch for clarity, and where applicable, if multiple different mismatches were introduced, they are simply described as MM1, MM2 to differentiate this. On the microarrays, the 10% threshold is comparable to a S/N of approximately 2. Thus, values below this are background limited.

FIG. 5. represents an exemplary AVR array images of a (A) sensitive H3N2 virus and (B) resistant H3N2 due to a mutation at position 805. The dark spots represent strong fluorescence signal. Influenza specific sequence groups are boxed in thin black lines (MP positive control upper left of a and b), 793 (lower left) and 805 (right) are boxed in black. The sensitive/resistant ratio is the mean signal from the triplicate sensitive spots (boxed in light grey) divided by the mean signal of resistant spots (boxed in dark grey).

FIG. 6. represents an exemplary AVR array images of a (A) sensitive H1N1 virus and (B) resistant H1N1 with mutation at position 793. The sensitive/resistant ratio is the mean signal of the triplicate spots for the sensitive sequences (boxed in light grey) divided by the mean signal of the resistant sequences (boxed in dark grey).

### DESCRIPTION OF ILLUSTRATIVE EMBODIMENTS

### Definitions

Terms that are not otherwise defined herein are used in accordance with their plain and ordinary meaning.

As used herein, “a” or “an” may mean one or more than one of an item.

A “sequence variant” is any variation in a nucleic acid sequence, such as the variations observed in a given gene sequence between different strains, types or subtypes of influenza virus. Sequence variants may include, but are not limited to, insertions, deletions, substitutions, mutations and single nucleotide polymorphisms.

A “capture” probe or sequence is a nucleic acid sequence that, whether or not associated with a solid surface, will hybridize to or capture a target nucleic acid.

A “label” probe or sequence is a nucleic acid sequence that will hybridize to a target nucleic acid sequence to provide a detectable signal that indicates the presence of the target.

A “label” probe or sequence may be detectably labeled, for example by attachment of a fluorescent, phosphorescent, enzymatic, radioactive or other tag moiety. Alternatively, a label probe or sequence may contain one or more functional groups designed to bind to a detectable tag moiety.

### DESCRIPTION

In the following sections, various exemplary compositions and methods are described in order to detail various embodiments of the invention. It will be obvious to one skilled in the art that practicing the various embodiments does not require the employment of all or even some of the specific details outlined herein, but rather that concentrations, times and other specific details may be modified through routine experimentation. In some cases, well known methods or components have not been included in the description.

In accordance with the present invention there may be employed conventional molecular biology, microbiology, and recombinant DNA techniques within the skill of the art. Such techniques are explained fully in the literature. See, e.g., Sambrook, Fritsch & Maniatis, Molecular Cloning: A Laboratory Manual, Second Edition 1989, Cold Spring Harbor Laboratory Press, Cold Spring Harbor, N.Y.; Animal Cell Culture, R. I. Freshney, ed., 1986).

### Influenza Antiviral Treatment

Once a subject is diagnosed with an influenza infection, within 24-48 hours of the onset of symptoms, one course of treatment can be to prescribe antiviral therapy. These therapies limit the duration and severity of infection. Some antiviral drugs are currently available for treatment of persons infected with influenza. These antiviral agents include but are not limited to ion channel inhibitors amantadine and rimantadine, and the neuraminidase inhibitors zanamivir and oseltamivir.

One disadvantage to using antiviral agents to treat a viral infection is that viruses vary in response to these agents. Often, a virus is found to be resistant to certain antiviral treatments. One current method of characterization of influenza virus involves hemagglutinin-inhibition serology tests, with viral cultures often necessary for more detailed characterization. Many of the traditional approaches are laborious and time-consuming, making them unsuitable for rapid diagnosis in a clinical or field setting. In addition, the current rapid influenza tests are relatively insensitive, therefore false negatives are a common occurrence.

In one embodiment of the present invention, viral-containing samples can be analyzed for antiviral agent sensitivity or resistance of the virus. In one embodiment, the virus can be influenza. One example of an antiviral agent are the adamantanes. Adamantanes have been known to reduce virus replication. Amantadine, and its methylated derivative rimantadine, are cage like molecules that act against the M2 ion channel of influenza. It is thought that these drugs rest within the ion channel and prevent viral uncoating and entry into the cell. The low cost and simple methods for production of these drugs have led to extensive worldwide use in both human and animal populations. Adamantanes act on influenza A and not for influenza B.

In another embodiment, an apparatus of the present invention may involve the sensisitivity or resistance assessment of a virus to a neuraminidase inhibitor (NAI). NAI treatments currently available are marketed under the brand names Relenza™ (zanamivir) and Tamiflu™ (the prodrug oseltamivir). Other antiviral agents of use in the present invention include but are not limited to a prodrug A-315675 and Peramivir. NAIs act by preventing viral release from infected cells and thus interfere With the virus's ability to infect new host cells. Neuraminidase has a highly conserved active site that provides an attractive antiviral target. Transition-state analog NAIs bind in the active site and work effectively against both influenza A and B to abrogate virus spread.

In another embodiment, an apparatus contemplated herein may include the sensisitivity or resistance assessment of a virus to the substituted pyrazine compound, T-705, and the fungal extract, flutimide, have shown some anti-influenza activity via their inhibitory effects on viral polymerase.

### Resistance to Adamantanes.

Influenza A and B viruses contain a unique protein, M2, that is produced by alternative splicing of the M segment. M2 is a proton-selective ion channel that is incorporated into the membrane of virus particles and is required for virus entry into the host cell. The highly structured nature of this protein and its requirement for infection has made it a common for antiviral drugs.

It has been observed that there is a rapid emergence of resistance to adamantanes both in vivo and in vitro. In one example, resistance was associated with point mutations resulting in a single amino acid change of M2 or in other cases a double mutation. It is contemplated that embodiments of the present invention include identifying and using one or more genes having one or more mutations in an apparatus disclosed herein to identify the resistance or sensitivity of a virus to an antiviral agent. Shedding (release) of naturally occurring resistant viruses were reported from as many as 30% of patients during the 1980's and 1990's, although these viruses failed to circulate widely. Recently, resistant viruses have been found in a greater number of infected individuals. In a survey of worldwide isolates acquired during the 2003-2004 season, 12% of the influenza samples were drug resistant, a 30-fold increase over the same value for samples from 1994-1995. In another part of the world, samples from China and Hong Kong in 2003-2004, 73% were found with mutations for resistance. Furthermore, incidence of adamantane resistance was found in 92% of viruses isolated from United States patients from Oct. 1 to Dec. 31, 2005.

It is contemplated herein that apparati disclosed in the present invention may be used to analyze samples on a routine basis such as in a clinic setting or in the event of an outbreak of a particular virus in a makeshift setting to identify antiviral drugs of use to treat the outbreak.

In one embodiment, an apparatus of the present invention can include a particular mutation in the M gene segment of Influenza A, within the M2 coding region. In one exemplary method, M2 appeared in an influenza A sample after adamantanes treatment was used. Thus, it appeared that mutations in certain genes may have occurred due to exposure to the antiviral agent. In one particular embodiment, it has been demonstrated that a single point mutation may occur in the coding region of the ion channel that spans the phospholipid membrane. Point mutations result in single amino acid changes at residues 26, 27, 30, 31 or 34 of the M2 protein and do not appear to result in any virus growth impairment. The most common observed changes were valine-to-alanine (V27A) or serine-to-asparagine (S31N). Table 1 illustrates 5 known mutations and their corresponding nucleotide information.

### Resistance to Neuraminidase Inhibitors.

In another exemplary method neuraminidase resistance was examined. Neuraminidase resistance has also recently been found for both in vitro and in vivo studies. The highly dynamic nature of influenza has allowed observation of viable resistant viruses, including those acquired from patients treated with NAIs. In one study, it was observed that resistance development changes have occurred in two forms, NA-independent and NA-dependent. NA-independent resistance, which has thus far been seen as mutations within HA, reduced affinity of HA for its receptor binding site. The loss of affinity facilitates virus budding from infected cells and eliminates the need for a strong NA activity, even at the cost of a less effective initial binding interaction and impaired growth. Alternatively, NA-dependent mutations that alter drug binding have been discovered. These changes were originally only found in catalytic residues, but have recently been found in residues within the catalytic pocket as well as in the framework residues that interact with the catalytic pocket.

Although there have been a range of mutable positions conferring resistance to NAIs, several positions were most commonly seen. For mutants selected in vitro, mutations in positions 119 (E119D/A/G) and 292 (R292K) have been found. Various HA mutations were observed as well. NA mutations found in vivo, from either clinical isolates or ferrets, have been found at positions 119 (E119V/D), 150 (E150G), 152 (R152K), 198 (D198N), 199 (S199N), 274 (H274Y), and 292 (R292K).

### Historical Detection of Resistance.

One factor that lead to the current invention was the ability to reproducibly detect resistance to antivirals which has been a major challenge for researchers. One of the earlier developed method for resistance detection was the use of a plaque inhibition assay. This assay utilized a monolayer of Madin-Darby canine kidney (MDCK) cells that were incubated with a solution of virus. The number of plaques formed allowed the estimation of number of viruses in solution. Inclusion of an antiviral drug during incubation would generally result in a reduction of plaques in comparison to a standard. This assay was improved upon by using an enzyme-linked immunosorbent assay (ELISA) protocol, which allowed more reproducible and faster determination of the amount of virus. After incubation with the virus and/or drug, a primary antibody to the virus and an enzyme-conjugated secondary antibody were added to the cells. Detection was accomplished through the activity of the enzyme. The amount of product from the enzyme reaction was correlated with the amount of virus replication. ELISA of MDCK cells is considered the standard for resistance determination.

More recent alternatives for resistance determination include direct genotypic analysis to find changes that correspond with antiviral resistance. Multiple different methods have been developed to access these genetic changes. The primary method for analysis has been sequencing of the viral gene(s) or PCR-amplified products directly. A sequence comparison between a drug sensitive virus and drug resistant virus could be used to determine the changes causing resistance. Although whole genome sequencing provides a large amount of information about a virus, it requires a significant amount of time and/or expensive equipment for automated processing. In addition, variability in laboratory expertise has been shown to affect the quality of results obtained in virus sequencing.

In addition, knowledge of the mutable positions and/or regions associated with resistance has allowed development of several techniques to more quickly assay a few nucleotide positions of the genome. A PCR-restriction analysis, or restriction fragment length polymorphism (RFLP), methodology was developed to determine resistance mutations in patient samples. Restriction enzymes cut dsDNA at known sequences; mutation within this sequence would prevent the enzyme activity. Visualization of cut products by agarose gel electrophoresis allows determination of the presence or absence of a specific sequence. One limitation to this analysis was that a mutation in any of the nucleotides recognized by the enzyme could be responsible for loss of enzyme activity and would thus not necessarily correlate with resistance.

In one embodiment of the present invention, rapid sequencing methodologies may be used for example rapid sequencing of a small region of a genome can be performed by pyrosequencing. Pyrosequencing involves the sequential addition of single nucleotides to a growing chain of DNA. Production of pyrophosphate from each nucleotide addition starts an enzymatic cascade that results in an ATP-driven luciferase reaction. By controlling the nucleotide present during any given cycle, the primary sequence of the template can be determined. Due to the stepwise addition of nucleotides in this procedure, it can be difficult to get long sequencing reads.

Also, an oligonucleotide microarray platform can be used as one advantageous approach to genotyping due to the multiplexing capability and applied to antiviral resistance problems. Two literature sources reported testing for point mutations in bacteria M. tuberculosis and S. aureus and have shown the capability to detect and identify resistant samples. However, their approach relied on a large number of in situ synthesized probes that required costly fabrication.

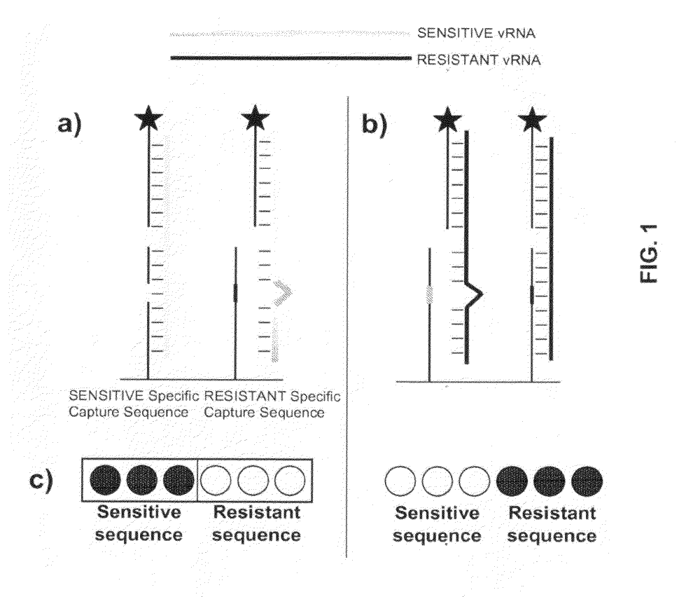

Disclosed herein is an array designed and used to detect antiviral agent resistance of a viral-containing sample. In one particular embodiment, adamantine resistance was analyzed for the presence or absence of an amino acid change in a viral sample. Two common amino acid changes, V27A and S31N, were specifically targeted using a small set of capture and label sequences. In another embodiment, sequence selection methods can be used in methods of the present invention. In one exemplary technique, the sequences were chosen that utilized a novel program, ConFind, to provide robust handling of incomplete sequence data, as is common with many of the current influenza genomes publically available, and that incorporated a phylogenetic analysis for data reduction. This process allowed efficient mining of large databases to find conserved regions within smaller groups of influenza sequences created from the entire database by the phylogenetic analysis. Capture sequences were chosen that corresponded to the 5 known mutable positions responsible for antiviral resistance. Label sequences were chosen to hybridized with portions of the M gene adjacent to the capture sequences. (U.S. Application No. 60/759,670 filed on Jan. 18, 2006 entitled, “DNA Microarray Analysis as a Diagnostic Assay for Current and Emerging Strains of Influenza A, is incorporated herein by reference in its entirety). In one exemplary method, two capture probes were applied for each sequence chosen; one a match for a sensitive virus and one a match for a resistant virus (FIG. 1). One fundamental aspect of this example can be the ability to detect a change in spot intensity due to a single nucleotide mismatch in one of the two probes (see Example section)

### Functional Genomics and Microchip-Platforms

With the advent of rapid genome sequencing and large genome databases, it is now possible to utilize genetic information in a myriad of ways. One of the most promising technologies is oligonucleotide arrays. The general structure of an oligonucleotide array, more commonly referred to as a DNA microarray or a DNA chip, is a well defined array of spots on an optically flat surface, each of which contains a layer of relatively short strands of DNA (e.g., Schena, ed., “DNA Microarrays A Practical Approach,” Oxoford University Press; Marshall et al. (1998) Nat. Biotechnol. 16:27-31; each incorporated herein by reference). Of the two most commonly used technologies for generating arrays, one is based on photolithography (e.g. Affymetrix) and the other is based on robot-controlled ink jet (spotbot) technology (e.g., Arrayit.com). Other methods for generating microarrays are known and any such known method may be used. Generally, the sequence of the ss-oligonucleotide (capture sequence) placed within a given spot in the array is selected to be complimentary to a single strand of the target sequence within the sample. The aqueous sample is placed in contact with the array under the appropriate hybridization conditions. The array is then washed thoroughly to remove all non-specific adsorbed species. In order to determine whether or not the target sequence was captured, the array is “developed” by adding, typically, a fluorescently labeled oligonucleotide sequence that is complimentary to an unoccupied portion of the target sequence. In certain methods, a microarray is then “read” using a microarray reader or scanner, which outputs an image of the array. Spots that exhibit strong fluorescence are positive for that particular target sequence.

DNA chip technology has found widespread use in gene expression analysis and there are now several demonstrations of DNA chips in the field of diagnostics.

Embodiments of the present invention have several advantages over the viral assays to date, namely assays for identifying resistant or sensitive strains of influenza. In one embodiment, a chip assay disclosed in the present invention targets one or more genes of a virus. A chip assay disclosed herein has a more rapid turn around time for analysis. In accordance with this embodiment, the turnaround time for analysis of a viral-containing sample for resistance or sensitivity to antiviral agent may require 11 hours or less. In a particular embodiment, analysis of a viral-containing sample for resistance or sensitivity to antiviral agent may require 7 hours or less. In another particular embodiment, analysis of a viral-containing sample for resistance or sensitivity to antiviral agent may require 5 hours or less. In addition, the chip assay for analysis of the resistance or sensitivity of a virus to an antiviral agent disclosed herein may require 300 or less, 200 or less, preferably 25-150 sequences, more preferably 30-100 sequences to identify the resistance or sensitivity of a virus gene of a particular type, subtype or strain of a virus (e.g. M segment of influenza A H1N1). In accordance with these embodiments, analysis of a viral-containing sample for resistance or sensitivity to antiviral agent may require about 100 nucleotides or less for detection of a target genes or nucleotides indicative of the viral sensitivity or resistance. In one particular embodiment, analysis of a viral-containing sample for resistance or sensitivity to antiviral agent may require 50 nucleotides or less for detection of a target genes or nucleotides indicative of the viral sensitivity or resistance. For example, 5-15 sequences of about 10-50 nucleotides or 10 to 30 nucleotides in length may be used to generate a chip for identification of the resistance or sensitivity of a virus to an antiviral agent. In accordance with these embodiments, a skilled artisan understands that many of the sequences generated for detection of the genes or gene segments indicative of sensitivity or resistance of a viral organism to an antiviral agent may have overlap.

An important issue for using a DNA microarray to analyze viral strains is identifying what gene of the viral genome such as the influenza genome to target for sensitivity or resistance conference to an antiviral agent. For example, each type of influenza (A, B, and C) is varies in the sensitivity or resistance to an antiviral agent. Sequences placed on the microarray must preferably distinguish between the various sensitivities and resistance of viruses such as influenza. Additionally, influenza virus mutates extremely rapidly. Thus, sequences placed on the microarray must preferably take into account the rapid mutational rate of influenza.

In the present invention, a single gene indicative of a viral sensitivity or resistance may be targeted and the apparatus produced by generating specific sequences of this gene to distinguish the resistance or sensitivity in a viral sample. One example detailed herein unexpectedly found that a single gene (e.g. M segment of influenza A) may be used. In one example, the present invention discloses that a target gene such as the M segment gene of influenza virus A may be used to identify the resistance or sensitivity to an antiviral agent of a specific subtype of the virus. In accordance with this embodiment, analysis of an M segment gene of subtypes H1N1, H3N2, and H5N1 of influenza A may be analyzed.

In one example, the M segment of influenza A can be used to provide sensitivity or resistance information of the virus to antiviral agents by examining for the presence or absence of mutations within the gene. The M segment of influenza A codes for both the M1 and M2 proteins. M1 is the most abundant protein in the virion and forms the inside of the viral envelope. M1 serves as a bridge between HA, NA, and M2 and the viral core. M1 is involved in a number of steps in the life cycle of the virus, including the transport of the ribonucleoproteins, viral assembly, and budding. M2 is a minor component of the viral envelope that acts as a proton-selective ion channel. Inside the acidic endosome after viral and endosomal membrane fusion, the M2 ion channel opens and facilitates the low-pH environment needed to uncoat the ribonucleoprotein.

The second aspect of gene target selection is to choose which sequences within each identified region to place on the DNA microarray. For example a chip was designed for analysis of the M gene of influenza A for sensitivity to adamantanes. Ultimately, different M segment sequences were positioned on a microarray corresponding to different mutational regions. Appropriate probe sequences (capture and label) were then designed for the selected regions (see Methods). Probe sequences were selected to yield either broad reactivity with all viral subtypes or highly specific reactivity for a given viral mutation. Anticipated reactivity was determined computationally by evaluating the number of mismatches between possible probe sequences and all sequences in the databases used to design them. These sequences were designed to specifically identify influenza A M gene sensitive or resistant to adamantanes. The following procedure was used to identify whether a virus was sensitive or resistant to an antiviral agent.
(1) Amplify the viral RNA by first converting it into cDNA using reverse transcriptase-PCR.
(2) Amplify the cDNA into a double stranded DNA template using PCR
(3) Convert the dsDNA template into large amounts of RNA using T7 RNA polymerase.
(4) Fragment the RNA using base catalyzed hydrolysis.
(5) Add a mixture of specific label-oligonucleotides to the fragmented RNA. Only one label oligonucleotide will bind to each region that the microarray is designed to capture.
(6) Place the mixture of fragmented influenza RNA and label-oligos onto the microarray, and allow hybridization to occur.
(7) Wash off any unbound RNA/DNA.
(8) Analyze using a scanning laser fluorimeter.

The detailed procedures are described in the Examples section below. In one exemplary study viral samples were tested for sensitivity or resistance to an antiviral agent. Methods disclosed herein were used to identify the sensitivity or resistance of each viral sample.

Correct Sensitivity or Resistance to Antiviral Agent: 96% of samples tested

False negative: 4%

False positive: 2% of samples tested

Thus, the AVRChip™ apparatus accurately provided accurate information on susceptibility to antivirals in much less time than current procedures.

In some embodiments of the present invention, a single gene is targeted in a virus. In accordance with these embodiments, a single gene can be an M segment of influenza virus.

In other embodiments of the present invention, it is contemplated that other viruses have proteins similar to the M segment of influenza A that may be targeted and capture and label sequences may be produced. From these capture and label sequences, a microarray chip (AVRChip™, where AVR is the designation of antiviral resistance chip) may be created for identifying susceptibility to an agent. In accordance with these embodiments, other viruses may include negative sense, single-strand, segmented RNA viruses. In one particular embodiment, a negative sense, single-strand, segmented RNA virus may include viruses of the class Orthomyxovyridae. Orthomyxovyridae viruses include but are not limited Influenzavirus A, Influenzavirus B, Influenzavirus C, Thogotovirus and Isavirus.

In yet other embodiments, it is contemplated herein that methods and apparati disclosed can be used for analysis of other influenza virus strains including, but not limited to, any combination of Influenza A, H, and N subtypes, as well as, influenza B types, influenza C types, H1N1, H3N2, H5N1H7N7, H9N2, H1N2, and H3N8. For example there 15 HA's and 9 NA's, thus up to 135 combinations are possible and are contemplated herein. In a more particular embodiment, strains contemplated of use in the methods and apparati disclosed include H1N1, H3N2, and H5N1.

Other embodiments contemplated herein can include detection of resistance associated with a change in any genes of influenza such as M, NA, HA, PB2, PB1, PA, HA, NP, NA, M1, M2, NS1 and NS2.

### Kits

In still further embodiments, the present invention concerns kits for the methods described herein. In one embodiment, a viral (such as a pathogenic or non-pathogenic virus) resistance or sensitivity detection kit is contemplated. In another embodiment, a kit for analysis of a sample from a subject having a virally-induced infection is contemplated. In a more particular embodiment, a kit for analysis of a sample from a subject having or suspected of developing an influenza-induced infection is contemplated. In accordance with this embodiment, the kit may be used to assess the sensitivity or resistance of the virus.

The kits may include a microarray chip system within a tube or other suitable vessel. In addition, the kit may include a stick or specialized paper such as a dipping stick or dipping paper capable of rapidly analyzing a sample for example, within a healthcare facility by a healthcare provider. In another embodiment, the kit may be a portable kit for use at a specified location outside of a healthcare facility.

The container means of any of the kits will generally include at least one vial, test tube, flask, bottle, syringe or other container means, into which the testing agent, may be preferably and/or suitably aliquoted. The kits of the present invention may also include a means for comparing the results such as a suitable control sample such as a positive and negative control. A suitable positive control may include a sample of a known viral type, subtype or strain.

### Nucleic Acids

In various embodiments, isolated nucleic acids may be analyzed to detect and/or diagnose types, subtypes or even strains of influenza virus. The isolated nucleic acid may be derived from genomic RNA or complementary DNA (cDNA). In other embodiments, isolated nucleic acids, such as chemically or enzymatically synthesized DNA, may be of use for capture probes, primers and/or labeled detection oligonucleotides.

A “nucleic acid” includes single-stranded and double-stranded molecules, as well as DNA, RNA, chemically modified nucleic acids and nucleic acid analogs. It is contemplated that a nucleic acid may be of 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, about 110, about 120, about 130, about 140, about 150, about 160, about 170, about 180, about 190, about 200, about 210, about 220, about 230, about 240, about 250, about 275, about 300, about 325, about 350, about 375, about 400, about 425, about 450, about 475, about 500, about 525, about 550, about 575, about 600, about 625, about 650, about 675, about 700, about 725, about 750, about 775, about 800, about 825, about 850, about 875, about 900, about 925, about 950, about 975, about 1000, about 1100, about 1200, about 1300, about 1400, about 1500, about 1750, about 2000 or greater nucleotide residues in length, up to a full length protein encoding or regulatory genetic element.

### Construction of Nucleic Acids

Isolated nucleic acids may be made by any method known in the art, for example using standard recombinant methods, synthetic techniques, or combinations thereof. In some embodiments, the nucleic acids may be cloned, amplified, or otherwise constructed.

The nucleic acids may conveniently comprise sequences in addition to a type, subtype or strain associated viral sequence. For example, a multi-cloning site comprising one or more endonuclease restriction sites may be added. A nucleic acid may be attached to a vector, adapter, or linker for cloning of a nucleic acid. Additional sequences may be added to such cloning and sequences to optimize their function, to aid in isolation of the nucleic acid, or to improve the introduction of the nucleic acid into a cell. Use of cloning vectors, expression vectors, adapters, and linkers is well known in the art.

### Recombinant Methods for Constructing Nucleic Acids

Isolated nucleic acids may be obtained from bacterial, viral or other sources using any number of cloning methodologies known in the art. In some embodiments, oligonucleotide probes which selectively hybridize, under stringent conditions, to the nucleic acids are used to identify a viral sequence. Methods for construction of nucleic acid libraries are known and any such known methods may be used. [See, e.g., Current Protocols in Molecular Biology, Ausubel, et al., Eds., Greene Publishing and Wiley-Interscience, New York (1995); Sambrook, et al., Molecular Cloning: A Laboratory Manual, 2nd Ed., Cold Spring Harbor Laboratory Vols. 1-3 (1989); Methods in Enzymology, Vol. 152, Guide to Molecular Cloning Techniques, Berger and Kimmel, Eds., San Diego: Academic Press, Inc. (1987).]

### Nucleic Acid Screening and Isolation

Viral RNA or cDNA may be screened for the presence of an identified genetic element of interest using a probe based upon one or more sequences. Various degrees of stringency of hybridization may be employed in the assay. As the conditions for hybridization become more stringent, there must be a greater degree of complementarity between the probe and the target for duplex formation to occur. The degree of stringency may be controlled by temperature, ionic strength, pH and/or the presence of a partially denaturing solvent such as formamide. For example, the stringency of hybridization is conveniently varied by changing the concentration of formamide within the range of 0% to 50%. The degree of complementarity (sequence identity) required for detectable binding will vary in accordance with the stringency of the hybridization medium and/or wash medium. The degree of complementarity will optimally be 100 percent; however, minor sequence variations in the influenza RNA that result in <100% complementarity between the influenza RNA and capture sequences, probes and primers may be compensated for by reducing the stringency of the hybridization and/or wash medium.

High stringency conditions for nucleic acid hybridization are well known in the art. For example, conditions may comprise low salt and/or high temperature conditions, such as provided by about 0.02 M to about 0.15 M NaCl at temperatures of about 50° C. to about 70° C. Other exemplary conditions are disclosed in the following Examples. It is understood that the temperature and ionic strength of a desired stringency are determined in part by the length of the particular nucleic acid(s), the length and nucleotide content of the target sequence(s), the charge composition of the nucleic acid(s), and to the presence or concentration of formamide, tetramethylammonium chloride or other solvent(s) in a hybridization mixture. Nucleic acids may be completely complementary to a target sequence or may exhibit one or more mismatches.

### Nucleic Acid Amplification

Nucleic acids of interest may also be amplified using a variety of known amplification techniques. For instance, polymerase chain reaction (PCR) technology may be used to amplify target sequences directly from viral RNA or cDNA. PCR and other in vitro amplification methods may also be useful, for example, to clone nucleic acid sequences, to make nucleic acids to use as probes for detecting the presence of a target nucleic acid in samples, for nucleic acid sequencing, or for other purposes. Examples of techniques of use for nucleic acid amplification are found in Berger, Sambrook, and Ausubel, as well as Mullis et al., U.S. Pat. No. 4,683,202 (1987); and, PCR Protocols A Guide to Methods and Applications, Innis et al., Eds., Academic Press Inc., San Diego, Calif. (1990). PCR-based screening methods have been disclosed. [See, e.g., Wilfinger et al. BioTechniques, 22(3): 481-486 (1997).]

### Synthetic Methods for Constructing Nucleic Acids

Isolated nucleic acids may be prepared by direct chemical synthesis by methods such as the phosphotriester method of Narang et al., Meth. Enzymol. 68:90-99 (1979); the phosphodiester method of Brown et al., Meth. Enzymol. 68:109-151 (1979); the diethylphosphoramidite method of Beaucage et al., Tetra. Lett. 22:859-1862 (1981); the solid phase phosphoramidite triester method of Beaucage and Caruthers, Tetra. Letts. 22(20):1859-1862 (1981), using an automated synthesizer as in Needham-VanDevanter et al., Nucleic Acids Res., 12:6159-6168 (1984); or by the solid support method of U.S. Pat. No. 4,458,066. Chemical synthesis generally produces a single stranded oligonucleotide. This may be converted into double stranded DNA by hybridization with a complementary sequence, or by polymerization with a DNA polymerase using the single strand as a template. While chemical synthesis of DNA is best employed for sequences of about 100 bases or less, longer sequences may be obtained by the ligation of shorter sequences.

### Covalent Modification of Nucleic Acids

A variety of cross-linking agents, alkylating agents and radical generating species may be used to bind, label, detect, and/or cleave nucleic acids. For example, Vlassov, V. V., et al., Nucleic Acids Res (1986) 14:4065-4076, disclose covalent bonding of a single-stranded DNA fragment with alkylating derivatives of nucleotides complementary to target sequences. A report of similar work by the same group is that by Knorre, D. G., et al., Biochimie (1985) 67:785-789. Iverson and Dervan also showed sequence-specific cleavage of single-stranded DNA mediated by incorporation of a modified nucleotide which was capable of activating cleavage (J Am Chem Soc (1987) 109:1241-1243). Meyer, R. B., et al., J Am Chem Soc (1989) 111:8517-8519 disclose covalent crosslinking to a target nucleotide using an alkylating agent complementary to the single-stranded target nucleotide sequence. A photoactivated crosslinking to single-stranded oligonucleotides mediated by psoralen was disclosed by Lee, B. L., et al., Biochemistry (1988) 27:3197-3203. Use of crosslinking in triple-helix forming probes was also disclosed by Home, et al., J Am Chem Soc (1990) 112:2435-2437. Use of N4, N4-ethanocytosine as an alkylating agent to crosslink to single-stranded oligonucleotides has also been disclosed by Webb and Matteucci, J Am Chem Soc (1986) 108:2764-2765; Nucleic Acids Res (1986) 14:7661-7674; Feteritz et al., J. Am. Chem. Soc. 113:4000 (1991). Various compounds to bind, detect, label, and/or cleave nucleic acids are known in the art. See, for example, U.S. Pat. Nos. 5,543,507; 5,672,593; 5,484,908; 5,256,648; and, 5,681,941.

### Nucleic Acid Labeling

In various embodiments, tag nucleic acids may be labeled with one or more detectable labels to facilitate identification of a target nucleic acid sequence bound to a capture probe on the surface of a microchip. A number of different labels may be used, such as fluorophores, chromophores, radio-isotopes, enzymatic tags, antibodies, chemiluminescent, electroluminescent, affinity labels, etc. One of skill in the art will recognize that these and other label moieties not mentioned herein can be used. Examples of enzymatic tags include urease, alkaline phosphatase or peroxidase. Colorimetric indicator substrates can be employed with such enzymes to provide a detection means visible to the human eye or spectrophotometrically. A well-known example of a chemiluminescent label is the luciferin/luciferase combination.

In preferred embodiments, the label may be a fluorescent, phosphorescent or chemiluminescent label. Exemplary photodetectable labels may be selected from the group consisting of Alexa 350, Alexa 430, AMCA, aminoacridine, BODIPY 630/650, BODIPY 650/665, BODIPY-FL, BODIPY-R6G, BODIPY-TMR, BODIPY-TRX, 5-carboxy-4′,5′-dichloro-2′,7′-dimethoxy fluorescein, 5-carboxy-2′,4′,5′,7′-tetrachlorofluorescein, 5-carboxyfluorescein, 5-carboxyrhodamine, 6-carboxyrhodamine, 6-carboxytetramethyl amino, Cascade Blue, Cyt, Cy3, Cy5,6-FAM, dansyl chloride, Fluorescein, HEX, 6-JOE, NBD nitrobenz-2-oxa-1,3-diazole), Oregon Green 488, Oregon Green 500, Oregon Green 514, Pacific Blue, phthalic acid, terephthalic acid, isophthalic acid, cresyl fast violet, cresyl blue violet, brilliant cresyl blue, para-aminobenzoic acid, erythrosine, phthalocyanines, azomethines, cyanines, xanthines, succinylfluoresceins, rare earth metal cryptates, europium trisbipyridine diamine, a europium cryptate or chelate, diamine, dicyanins, La Jolla blue dye, allopycocyanin, allococyanin B, phycocyanin C, phycocyanin R, thiamine, phycoerythrocyanin, phycoerythrin R, REG, Rhodamine Green, rhodamine isothiocyanate, Rhodamine Red, ROX, TAMRA, TET, TRIT (tetramethyl rhodamine isothiol), Tetramethylrhodamine, and Texas Red. These and other labels are available from commercial sources, such as Molecular Probes (Eugene, Oreg.).

### EXAMPLES

The following examples are included to illustrate various embodiments. It should be appreciated by those of skill in the art that the techniques disclosed in the examples which follow represent techniques discovered to function well in the practice of the claimed methods, compositions and apparatus. However, those of skill in the art should, in light of the present disclosure, appreciate that many changes may be made in the specific embodiments which are disclosed and still obtain a like or similar result without departing from the spirit and scope of the invention.

### Example 1

### Selection of Influenza Virus Target Sequences of the M Segment for Analysis of Sensitivity or Resistance of the Virus to Antiviral Agents

### Experimental

### Single Nucleotide Discrimination Testing.

In one exemplary method, capture sequence A-MP-24C was chosen to test for discrimination of single nucleotide changes. Single nucleotides within this sequence were changed to introduce a mismatch between the influenza RNA and that capture sequence. Sequences selected are shown in Table 2 along with the matched sequence A-MP-24C. Designed “mismatch” sequences were ordered from Operon Biotechnologies, Inc. (Huntsville, Ala.). Sequences for the mismatch array were spotted in 0.7× Bio-Rad spotting buffer, cured at saturating humidity for 24 h and stored at −20° C. until needed. A cross-reactivity test between the new mismatch oligos and labels confirmed there were no cross-reactive interactions. RNA from A/TAIWAN/1571/2004, an H1N1 virus, was amplified, fragmented and hybridized in duplicate to the mismatch array, then washed and scanned. Microarray quantitation of the scanned images was performed with the VerseArray software package.

### Programs Used.

In another exemplary embodiment, in addition to programs previously defined, two novel programs developed herein were used in the sequence selection process. In one example, rm_dup program was written in Python and is designed to eliminate duplicate and/or identical sequences from an aligned .fas file. It removes duplicates by comparing accession numbers and by comparing genome sequence data. Removal of duplicate genome data, while often eliminating valid sequences, prevented artificial weighting of the database to clusters of genomes that collected in one region over a short period of time. The gen_mismatch_report program compares individual oligonucleotides found in the sequence selection process with the corresponding region of all genomes present in each subtree selected from the parent database. Mismatches with a sequence were grouped into 0, 1, 2, 3, 4-6, 7-10, or 10+ mismatches and output as a percentage of sequences within that subtree containing the number of mismatches.

### Antiviral Microarray Sequence Selection.

In certain examples, sequences were selected using a modified protocol as described. The database for antiviral microarray sequences selection gathered from the Los Alamos National Labs Influenza Sequence Database included all M gene sequences (1018 total) present in the database on Feb. 1, 2006. In addition, 1194 sequences of ‘influenza segment 7’ (M gene) were collected from NCBI's nucleotide database on the same date. Sequence files with either identical accession numbers or identical nucleotide sequences were removed using rm_dup. The final database of 1086 influenza sequences was aligned using Clustal W.

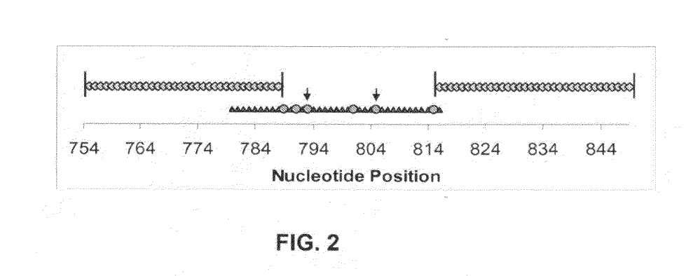

From this database, DNADIST was used to create a phylogenetic tree using only sequence data from nucleotide positions 754-849. This region includes nucleotides that code for amino acid residues 26-34 of the M2 protein, and an additional 35 nucleotides on either side of this coding region. Analysis, phylogenetic grouping and conserved region selection were performed. A modified version of find_oligos was used to select single sequences (either capture or label) independently, without the previously required restriction that they be chosen selected together and were 1 nt apart. Oligos were scored and picked using score_oligos and pick_oligos. All picked oligos were examined using gen_mismatch_report, to determine which sequences best covered the 1086 sequences in the database. Label sequences were chosen from the more conserved nucleotide regions 754-789 and 816-849. Capture sequences were selected that covered the five known mutable positions within the M2 gene and in which the mutable position was at least 6-8 nucleotides from either end of the oligo. A cartoon showing the locations used for selection of capture and label sequences and the known positions of resistance is shown in FIG. 2. The sequences were chosen regardless of the actual nucleotide at the mutable position. Limited coverage of the selected capture probes for specific nodes of the phylogenetic tree necessitated a second analysis with find_oligos in which the length parameter was reduced to 16-18 nt and preference towards longer sequences over shorter ones was removed. The oligos were scored, picked as described above and combined with previously picked capture sequences. A total of 111 sequences were “picked” by the automated pick_oligo program through both rounds of selection. Due to the large bias of mutations to either V27A or S31N from in vivo and in vitro samples, it was decided that proof-of-principle could be accomplished with selection of capture sequences specific to these two positions. From the picked file of 111 sequences, 8 label sequences (4 from nt 754-789 and 4 from nt 816-849) were selected based on their coverage of the 1086 influenza sequences. A total of 13 capture sequences (8 targeting position 805 and 5 targeting position 793) were initially selected as well.

Analysis of the capture sequences selected for position 793 showed that a number of database genomes were not covered by the picked capture sequences. Missed sequences were sorted and compiled into a new file, reduced to only nucleotide positions 781-817 and reanalyzed. The modified find_oligos was used to output additional sequences which were then scored, picked and selected from to get an additional 2 capture sequences for probing nucleotide position 793. Selected sequences are shown in Table 3. For each capture sequence selected, two probes were ordered. The first would be a perfect match with a sensitive virus (sensitive specific) and the second would contain be perfectly matched for a resistant virus (resistant specific).

### Microarray Preparation and Cross-Reactivity Testing.

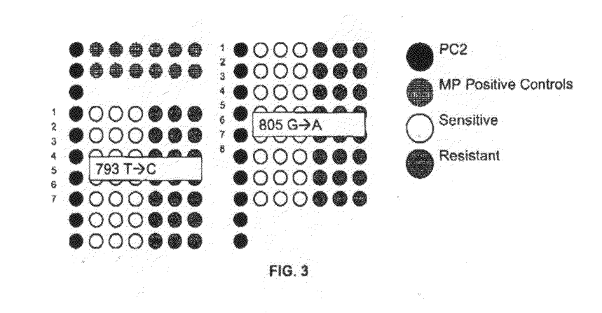

Capture and label sequences were acquired, prepared and spotted as described in 2.2 except the spotting buffer used was 1.2× BioRad spotting buffer. The antiviral microarray (AVR array) layout is shown in FIG. 3. Each capture probe was spotted in triplicate. The left-most row of spots in each group (shown in yellow) is the positive control sequence (PC) used for orientation when viewing. Four sequences were included as controls for influenza M RNA and include A-MP-158C, A-MP-209C, A-MP-239C and A-MP-919C. These sequences produced hits in the presence of most influenza samples. Capture sequences designed to probe for mutations at either 793 or at 805 were spotted in triplicate and grouped together with the ‘sensitive specific oligo’ spotted first followed by the ‘resistant specific oligo’ spotted.

### Samples.

Initial testing on the AVR array was done with 33 samples of known resistance/sensitivity from the CDC 72 sample study. These samples included 17 sensitive (S) H3N2, 9 S-H1N1, 5 resistant (R) H3N2, 1 R-H1N1 and 1 R-H5N1, which had been previously determined as sensitive or resistant based on pyrosequencing analysis by the CDC. A set of 30 samples for testing with the AVR array. The samples were received as purified vRNA from influenza isolates, or negatives, and numbered 1-30 and included both sensitive and resistant virus samples of the H3N2 and H1N1 subtypes. This set of samples was used for training and validating of the AVR array.

A secondary set of 12 samples of the H3N2 and H1N1 virus subtype was acquired for a secondary blind study. These samples were received as purified vRNA and numbered 1-12. They were designated as ‘CDC 12 AVR’ samples. In addition, two negative samples designated CU Neg 1 and CU Neg 2 were added to this set as controls.

### RNA Processing and Hybridization.

In one exemplary method, viral RNA was RT-PCR amplified with the M specific primers SZ-A-M1f and T7-SZ-A-M1027r using the protocol described previously. Run-off transcribed RNA was stored at −20° C. for up to 2 week. For analysis, RNA was fragmented, mixed with the hybridization solution, and hybridized to the AVR array. The microarray was washed and scanned and images processed for both visual and quantitative analysis.

### Artificial Neural Network Sample Identification.

EasyNN Plus Software (Version 7.0j) package was used for neural net (NN) analysis. A NN program uses a pattern recognition process to identify unknown input data based on its training with input from known samples. In this case, input data was fluorescence intensities from microarray images. During training, validating samples, which were not used in training and that have a known identity, were used to verify the NN learning progress. When approximately >90% of the validating examples were identified correctly, training was stopped. The unknown sample data was queried and assigned a score, scaled between 0 and 1, based on the similarity of the data to the training examples. The output was then used to identify the sample. In this work, an output of 0.75 was chosen as a threshold for identification. The NN program was used with default settings that included automated learning and momentum rate optimization. Approximately 20% of the known examples were chosen at random from the training set by the NN program to be used as validating examples.

Verification of the neural network approach was done by performing a round-robin analysis of samples from the CDC 72 set and the addition 30 samples provided by the CDC. Only images that were devoid of contamination and or significant array artifacts were used to prevent improper training of the NN. Inputs used were the normalized mean signal/background values and a highest signal/background value, which aided in identification of negative samples. Output options were sensitive, resistant or negative. Samples were arranged according to subtype and resistance then were sequentially numbered 1 through 10. By first arranging similar subtypes and resistance, it was assured that similar samples (i.e. two R-H1N1 V27A) would end up in different groups. Each group was then queried as unknowns while the remaining 9 groups were used as training/validation examples. This allowed querying of the entire database and provided the largest possible and most diverse training set for analysis of each group.

### Identification of the CDC 12 AVR Samples.

Identification of the CDC 12 AVR samples was accomplished by using a combination of visual and NN identification protocols. For visual analysis, images were analyzed as described above. The NN analysis was split into two parts. The first approach had 3 output options and attempted to identify the samples as sensitive, resistant or negative. The second approach included 5 output options, S-H3N2, R-H3N2, S-H1N1, R-H1N1 or negative. Inputs for both methods were normalized mean signal/background values and a maximum mean signal/background measurement. This maximum signal/background value was included to improve the NN discrimination of negatives from virus samples.

### Mismatch Detection on a Microarray.

It was previously demonstrated that the position of a mismatch was the most important factor in determining the ability to discriminate between a match and a mismatch. Mismatches near the terminal ends of the capture probe were less destabilizing than those in the central portion of the sequence. In one example, a concern was the specific bases that composed the mismatch. Based on that study, mutations were made in the capture sequence A-MP-24C in order to assess the capability to detect single nucleotide changes using conditions established during testing of the FluChip™ A total of 12 sequences, each of which contained a single mutation, were spotted onto a microarray. A-MP-24C was chosen because of the reproducibly high signal generated with all types of influenza samples.

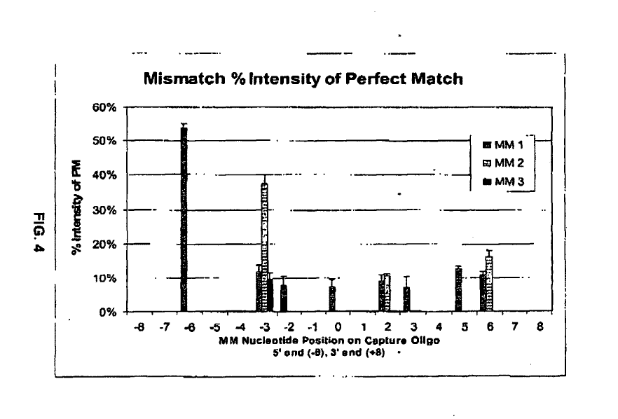

Results obtained for duplicate hybridizations using the mismatch array are shown in FIG. 4. mismatches present towards the terminal ends of the capture probe were less destabilizing (i.e., produced higher signal) than central mismatches. Mismatches on the 3′ end have a greater effect on hybridization than those near the 5′ end. This effect was attributed to the more solution like nature of the 3′ end, which contributes more to the stability of hybridization rather than the surface immobilized 5′ end of the sequence. The much higher intensity with MM2 at the −3 position correlates with data shown by Urakawa et al. where a G:U mismatch was generally less disruptive than the alternative mismatches T:U (position −3, MM1) or C:U (position −3, MM3). This result showed that it would be possible to distinguish between a perfect match and a mismatch in the FluChip length capture probes (<25 nt) when hybridized at 25° C. in hybridization solution containing 30% formamide.

### Detection of Antiviral Resistance on a Microarray.

It was anticipated that when RNA from a sensitive virus was hybridized, more fluorescence would be found from the sensitive capture probe and less fluorescence would be present on the resistant capture probe due to the mismatch present in that sequence. Thus, by examining the ratio of signal of the mean intensity from sensitive probes to the mean intensity from resistant probes (S/R), a quantitative determination could be made as to the antiviral susceptibility of the virus. A S/R ratio of greater than 1 would be indicative of sensitivity where as a ratio of less than 1 would correspond to a resistant virus.

### Sequence Selection Modifications.

The design of capture and label sequences for antiviral resistance mutations presented a challenge that required modification of the protocols established during the development of FluChip™-55. Notably, an examination of sequences selected during initial development of the FluChip™ showed that no sequences were chosen that cover the region that corresponds to adamantane resistance. Examination of Shannon entropy values over the region from 786-821, a 35 nt stretch that covers all 5 mutable positions, has 13 positions with entropy greater than 0.2. By comparison, the next 30 nt from 822-852 have only 3 positions with entropy values greater than 0.2. In one particular example, capture and label sequences were chosen separately. Choosing sequences separately required careful planning to prevent selection of sequences that were too far apart such that would be incapable of hybridizing to the same RNA fragment.

In one particular method, the fragmentation protocol established previously and used in this assay produces a maximum concentration of fragments between 38 and 150 nt. Thus, a large percentage of this RNA should still be capable of hybridization to both the capture and label sequence even if the distance between them increased. It was hoped that any loss in intensity by being spatially separated would be offset by the ease in design and detection of resistance. Capture probes would be designed in the highly variable region that covered the 5 known mutable positions and label sequences would be designed in the more conserved neighboring regions. An additional benefit of this approach was that a few label sequences could be designed for the entire influenza database and as many capture sequences as needed would cover the mutable positions. Fewer labels in solution reduced the chance of cross-reactivity.

Preliminary Testing of the AVR Array with CDC 72 Samples.

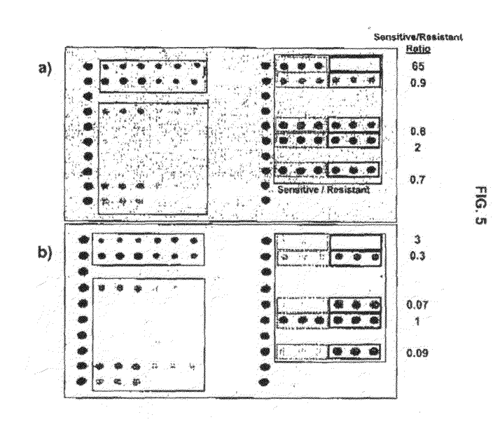

Of the CDC 72 samples studied with FluChip™—55, 33 had been tested by the CDC for adamantane sensitivity. These 33 samples were used in conjunction with the AVR array to define parameters for identifying a virus sample as sensitive or resistant. FIG. 5 shows contrast optimized images from (a) sensitive H3N2 and (b) resistant H3N2 (S31N) viruses. As described in the previous chapter, not all sequences were expected to hit for every virus due to the phylogenetic grouping approach for sequence selection. For example, in FIG. 3A, sequences 805-3, 4, and 7 selected did not produce significant hits when hybridized with H3N2 viruses. These sequences were selected from branches containing mostly swine and avian genomes. For the remaining five sequences (805-1,2,5,6, and 8) that hit, the S/R ratio was ˜1 or greater in all cases. By comparison, hybridization of a resistant virus produced a significantly lower S/R ratio due to a loss of intensity from sensitive specific sequences and increased intensity from the resistant specific sequences. The change in ratios between sensitive- and resistant-specific sequences was between 2 and 22-fold reduction; this change allowed identification of sensitive vs. resistant. Since no mutations were present in the 793-probing sequences, there was no change in intensity observed.

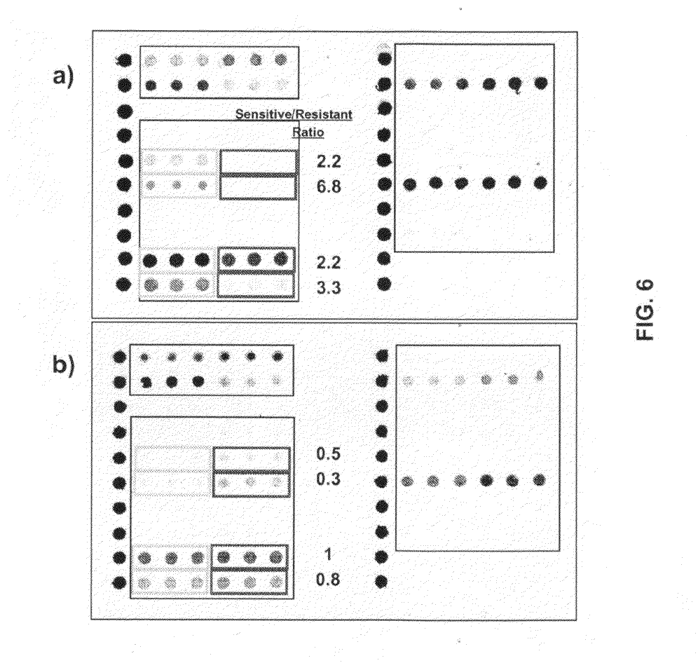

Example images of (A) sensitive H1N1 and (B) resistant H1N1 (V27A) viruses are shown in FIG. 6. In these images, the S/R values were in line with expectations; sensitive virus produced ratios greater than 1 and the resistant virus produced values that were generally less than 1. The ratio changes from a sensitive virus to a resistant virus were comparable to those that were seen in FIG. 3, a difference of ˜2 to 23-fold. Visually analyzing the images shown in both FIGS. 5 and 6 demonstrates how a simple visual examination could be used to determine virus sensitivity. In addition, the quantifiable change in ratios, which was dependent on the mean signals, suggested that a NN program would be able to successfully identify resistance as well.

### NN Identification of AVR Samples

In one exemplary analysis, all samples were combined into one data set and small subsets would be selected and queried against all other samples. It has been previously shown that using a training set that was too small reduced the accuracy of NN outputs. By rotating which group was queried, the entire database could be used as both training and querying, previously published method. Negatives samples were included to increase the validity of this approach.

To improve the quality of data used for training, all images were visually examined for spurious signals and/or other microarray artifacts that could have affected the data workup; eight influenza samples and six negative samples were removed from the data set. A total of 96 samples were included in this data set and divided into 10 groups. Each group was individually queried while the NN was trained with the remaining samples. Results from this study are summarized in Table 4. Of the samples, 96% were correctly identified, 4% were false negatives, and 2% were false positives. Analysis of the 96 samples translates into a clinical sensitivity of 95% and clinical specificity of 89%.

Of the samples that were missed, only two were false positives from negative control samples. Visual analysis of these two samples showed no significant spurious signals; they would easily be identified as negative by visual analysis. The inputs for the 16 negatives samples did show a wide range of values. This range of input varied from most input ˜0 to all inputs >50. This variation was not unexpected since normalization process automatically scales each input to the highest of the value of the group. Hall samples had nearly identical signals, the values would all be considered “high” and scaled to ˜100, but if one value was higher than the rest, this value would be scaled to 100 and the remaining values would be much less, or ˜0. One of the false negatives, an R-H1N1 (S31N), had a score of 0.694 for the resistant output, which was correct but just below the threshold of 0.75. The other three false negatives included R-H3N2 (V27A), R-H3N2 (S31N) and S-H1N1 samples. One sample, the H3N2 (S31N), was determined to have been accidentally included; visual analysis of this sample showed that a large portion of the array failed and thus this sample should have been discarded prior to analysis. Visual analysis of the remaining two false negatives failed to provide a reason for the incorrect assignment.

### NN Identification of CDC 12 AVR Samples.

After verifying that the NN could identify samples once it was adequately trained, 12 new influenza samples were provided and tested on an AVR array. A total of 101 samples were used for training and validation of the NN prior to querying with data from the 12 unknowns and 2 added negative controls. The samples were identified in 3 ways, a NN analysis with three output options (Negative, Sensitive or Resistant), a NN analysis with five outputs (Negative, Sensitive H1N1, Sensitive H3N2, Resistant H1N1, Resistant H3N2), and by visual analysis. In addition to the 18 inputs of normalized fluorescent intensity, a 19^{th} input of the highest mean signal was added to help discriminate the highly variable normalized intensities of negative samples from influenza samples. Of the 101 training samples, the highest mean signal for the negative samples averaged 1.4 where as for positive influenza samples this average was ˜200. The two NN approaches were combined to produce a consensus NN ID for the sample. This consensus was then compared to the visual analysis results and a decision made about what identity was reported.

In one exemplary illustration, a summary of the visual and NN identifications are presented in Table 5 review of the outputs for both NN approaches produced comparable answers when identifying the samples as sensitive, resistant or negative only. There were no conflicting answers where a single sample was listed as belonging to more than one category, thus a consensus for this identity was easily reached. Determination of the NN identified virus subtype only used the NN 5 output. For examples CDC 2 (no ID) and CDC 12 (both R-H3N2 and R-H1N1), where no subtype was selected, it was necessary to use extra care when examining the images visually to identify the virus subtype. After compiling the consensus identity and subtype from the NN outputs, they were compared with the visual analysis results. One discrepancy was noted. Sample CDC 1 was identified as resistant by both NN approaches but was identified as sensitive by visual analysis. A careful examination of that array image revealed that it was an H1N1 sample and was clearly sensitive at position 793. However, as an H1N1 virus, only two probes for 805 hit well. By manipulating the image contrast, sequence 805-8, which was shown to be critical in sensitive vs. resistant determination, showed a faint hit on the sensitive probe. Thus, the visual ID was chosen over the NN consensus ID. Samples CDC 2 and CDC 12 were subtyped based solely on visual analysis.

The results of the two-part unblinding and verification are summarized in Table 6. In the first part, identification of sensitive, resistant or negative for the CDC 12 AVR samples was found to be 100% correct. Since all sample ID's were found to be correct, no modification to the analysis, or re-analysis was necessary. The sample subtypes and mutated position were found to also be 100% correct. Although this blind study included only a small data set, the success in identifying each sample demonstrated the capability for microarray detection of resistance.

In one exemplary method, the capability to detect antiviral resistance on a microarray has been demonstrated herein. For example, sequences were chosen that utilized a novel program, ConFind, to provide robust handling of incomplete sequence data, as is common with many of the current influenza genomes publically available, and that incorporated a phylogenetic analysis for data reduction. This process allowed efficient mining of large databases to find conserved regions within smaller groups of influenza sequences created from the entire database by the phylogenetic analysis. Capture sequences were chosen that corresponded to the 5 known mutable positions responsible for antiviral resistance. Label sequences were chosen to hybridized with portions of the M gene adjacent to the capture sequences. It is contemplated herein that any other known selection method may be used in the disclosed methods. These selection processes allowed selection of probes that provided specificity for both sensitive and resistant influenza viruses. Adamantane resistant mutations V27A and S31N were successfully identified in a series of studies based on both visual and neural network identification. The round-robin approach verified that with a complete enough training set, a variety of samples could be identified. These results were taken a step further in correct identification of 12 samples in a blind study.

TABLE 1
Mutations associated with adamantane resistance.

| | | Nucleotide | Nucleotide |
|---|---|---|---|
| Amino acid* | Mutation | position* | change |
| 26 | Leu → Phe | 789 | C → U |
| | ″ | 791 | A → U, C |
| | ″ | 791 | G → U, C |
| 27 | Val → Ala | 793 | U → C |
| 30 | Ala → Thr | 801 | G → A |
| 31 | Ser → Asn | 805 | G → A |
| 34 | Gly → Glu | 814 | G → A |

*Depending on context, the mutated amino acid position and nucleotide position are used interchangeable throughout this chapter.

TABLE 2
Mismatch Study Microarray Sequences. Oligos
used during the Mismatch study to determine
capability to detect single nucleotide changes
under the current microarray conditions.

| | | Mismatch |
|---|---|---|
| Name | Sequence (5′ to 3′)^{a} | Position^{b} |
| A-MP-24-C | AGATGAGTCTTCTAACC | n/a |
| | Seq ID NO: 1 | |
| A-MP-24-3tu-C | AGtTGAGTCTTCTAACC | −6 |
| | Seq ID NO: 2 | |
| A-MP-24-6tu-C | AGATGtGTCTTCTAACC | −3 |
| | Seq ID NO: 3 | |
| A-MP-24-6gu-C | AGATGgGTCTTCTAACC | −3 |
| | Seq ID NO: 4 | |
| A-MP-24-6cu-C | AGATGcGTCTTCTAACC | −3 |
| | Seq ID NO: 5 | |
| A-MP-24-7ac-C | AGATGAaTCTTCTAACC | −2 |
| | Seq ID NO: 6 | |
| A-MP-24-9ag-C | AGATGAGTaTTCTAACC | 0 |
| | Seq ID NO: 7 | |
| A-MP-24-11ga-C | AGATGAGTCTgCTAACC | 2 |
| | Seq ID NO: 8 | |
| A-MP-24-11ca-C | AGATGAGTCTcCTAACC | 2 |
| | Seq ID NO: 9 | |
| A-MP-24-12ag-C | AGATGAGTCTTaTAACC | 3 |
| | Seq ID NO: 10 | |
| A-MP-24-14tu-C | AGATGAGTCTTCTtACC | 5 |
| | Seq ID NO: 11 | |
| A-MP-24-15tu-C | AGATGAGTCTTCTAtCC | 6 |
| | Seq ID NO: 12 | |
| A-MP-24-15cu-C | AGATGAGTCTTCTAcCC | 6 |
| | Seq ID NO: 13 | |

^{a}The nucleotide highlighted in red and lower case was modified to introduce a mismatch during hybridization.
^{b}The mismatch position was defined as a function of distance from the central oligonucleotide. In cases where multiple different mismatches were made at a single position (for example at −3 position), later discussion simple refers to replicates as MM1 (i.e., mismatch1), MM2, etc.

TABLE 3

Capture and label sequences chosen for detection
of resistance at V27A and S31N. Capture sequences
highlight the position to be probed (either 805 or 793).
Two oligos for each one selected were ordered
corresponding to both the sensitive (highlighted in bold)
and resistant (highlighted in italics)

| | | |
|---|---|---|
| Common | | |
| Name^{a} | Oligo Name | Sequence |

Label Sequences

| | |
|---|---|
| A-MP-754Q_AVRnd204r | AATGGGGGTGCAGATG |
| | Seq ID NO: 14 |
| A-MP-773Q_AVRnd351r | CGATTCAAGTGATCCT |
| | Seq ID NO: 15 |
| A-MP-754Q_AVRnd470r | GATGGGAGTGCAAATG |
| | Seq ID NO: 16 |
| A-MP-766Q_AVRnd818r-xx | GATGCAACGATTCAAGT |
| | Seq ID NO: 17 |
| A-MP-830Q_AVRnd204r | ATTGTGGATTCTTGAT |
| | Seq ID NO: 18 |
| A-MP-819Q_AVRnd375r | TTGCACTTGATATTGT |
| | Seq ID NO: 19 |
| A-MP-824Q_AVRnd449r | CCTGATATTGTGGATT |
| | Seq ID NO: 20 |
| A-MP-819Q_AVRnd1049r | TTGCACTTGATACTGT |
| | Seq ID NO: 21 |

Capture Sequences

| | | |
|---|---|---|
| 793-1 | A-MP-784C_793C_118r | ACCCGCTTGCTGTTGC |
| | | Seq ID NO: 22 |
| ″ | A-MP-784C_793T_118r | ACCCGCTTGTTGTTGC |
| | | Seq ID NO: 23 |
| 793-2 | A-MP-784C_793C_273r | ATCCTATTGCTGTTGCCG |
| | | Seq ID NO: 24 |
| ″ | A-MP-784C_793T_273r | ATCCTATTGTTGTTGCCG |
| | | Seq ID NO: 25 |
| 793-3 | A-MP-784C_793C_nd294r-x | ACCCTCTTGCTGTTGCTG |
| | | Seq ID NO: 26 |
| ″ | A-MP-784C_793T_nd294r-x | ACCCTCTTGTTGTTGCTG |
| | | Seq ID NO: 27 |
| 793-4 | A-MP-784C_793C_351r | ATCCTCTCGCTATTGC |
| | | Seq ID NO: 28 |
| ″ | A-MP-784C_793T_351r | ATCCTCTCGTTATTGC |
| | | Seq ID NO: 29 |
| 793-5 | A-MP-784C_793C_607r | ATCCTCTCGCTGTTGC |
| | | Seq ID NO: 30 |
| ″ | A-MP-784C_793T_607r | ATCCTCTCGTTGTTGC |
| | | Seq ID NO: 31 |
| 793-6 | A-MP-780C_793C_743r | AGTGATCCTCTTGCTGTTGCCGCAA |
| | | Seq ID NO: 32 |
| ″ | A-MP-780C_793T_743r | AGTGATCCTCTTGTTGTTGCCGCAA |
| | | Seq ID NO: 33 |
| 793-7 | A-MP-784C_793C_806r | ATCCTATTGCTGTTGCCGCAAATAT |
| | | Seq ID NO: 34 |
| ″ | A-MP-784C_793T_806r | ATCCTATTGTTGTTGCCGCAAATAT |
| | | Seq ID NO: 35 |
| 805-1 | A-MP-799C_805A_118r | CTGCGAATATCATTGGGA |
| | | Seq ID NO: 36 |
| ″ | A-MP-799C_805G_118r | CTGCGAGTATCATTGGGA |
| | | Seq ID NO: 37 |
| 805-2 | A-MP-792C_805A_189r | GTTGTTGCCGCGAATATAATTG |
| | | Seq ID NO: 38 |
| ″ | A-MP-792C_805G_189r | GTTGTTGCCGCGAGTATAATTG |
| | | Seq ID NO: 39 |
| 805-3 | A-MP-798C_805A_204r | GCAGCAAATATCATTG |
| | | Seq ID NO: 40 |
| ″ | A-MP-798C_805G_204r | GCAGCAAGTATCATTG |
| | | Seq ID NO: 41 |
| 805-4 | A-MP-798C_805A_211r | GCCGCAAACATCATTG |
| | | Seq ID NO: 42 |
| ″ | A-MP-798C_805G_211r | GCCGCAAGCATCATTG |
| | | Seq ID NO: 43 |
| 805-5 | A-MP-793C_805A_351r-x | TTATTGCCGCGAATATCATTG |
| | | Seq ID NO: 44 |
| ″ | A-MP-793C_805G_351r-x | TTATTGCCGCGAGTATCATTG |
| | | Seq ID NO: 45 |
| 805-6 | A-MP-790C_805A_734r-x | TTGTTGTTGCCGCGAATATCATTG |
| | | Seq ID NO: 46 |
| ″ | A-MP-790C_805G_734r-x | TTGTTGTTGCCGCGAGTATCATTG |
| | | Seq ID NO: 47 |
| 805-7 | A-MP-798C_805A_743r | GCCGCAAATATCATTG |
| | | Seq ID NO: 48 |
| ″ | A-MP-798C_805G_743r | GCCGCAAGTATCATTG |
| | | Seq ID NO: 49 |
| 805-8 | A-MP-793C_805A_1049r | TTGTTGCTGCGAATATCATTGGGA |
| | | Seq ID NO: 50 |
| ″ | A-MP-793C_805G_1049r | TTGTTGCTGCGAGTATCATTGGGA |
| | | Seq ID NO: 51 |

^{a}The “common name″ is used for clarity in discussions within the text.

TABLE 4
Summary of improved NN identification of influenza AVR samples.

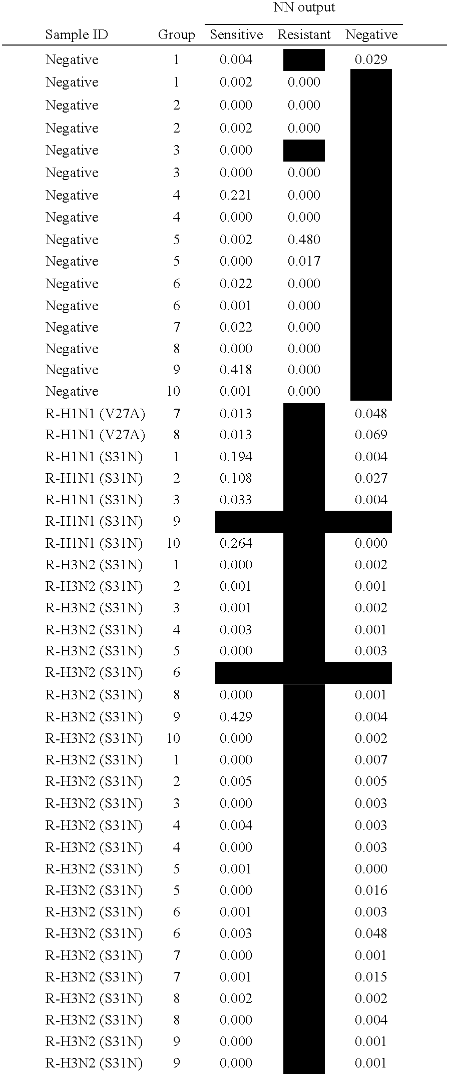

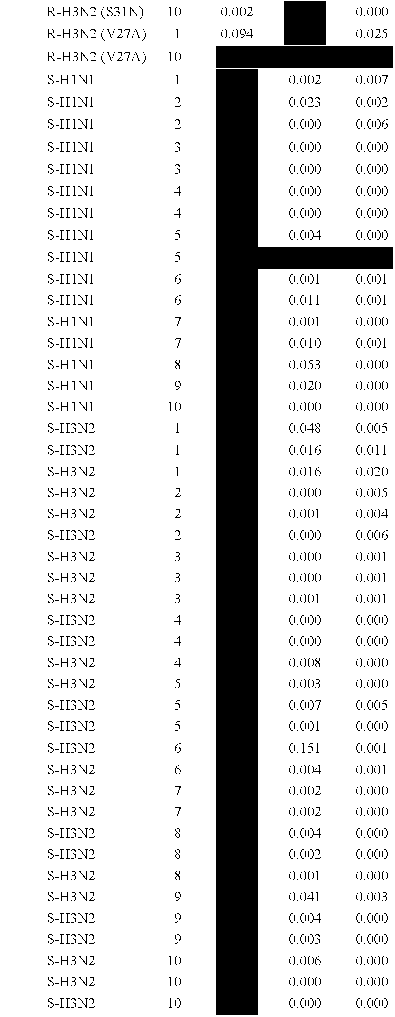

Samples highlighted in Bold = Correct, Dark grey = False Positive, Light grey = False Negative

TABLE 5
Summary of identification of CDC 12 AVR using three identification
methods. Visual identification was performed with contrast optimized
array images. The NN output threshold for identification was
established as 0.75 and anything below this value was listed as
no ID. The consensus of the NN outputs was used for comparison
with visual analysis.

| | | | NN 3 | NN |
|---|---|---|---|---|
| | Visual ID | NN 5 Output | Output | Consensus |
| CDC 1 | S-H1N1 | R H1N1 | Resistant | Resistant |
| CDC 2 | S-H3N2 | no ID | Sensitive | Sensitive |
| CDC 3 | R-H3N2 (V27A) | R H3N2 | Resistant | Resistant |
| CDC 4 | R-H3N2 (S31N) | R H3N2 | Resistant | Resistant |
| CDC 5 | S-H3N2 (odd) | S H3N2 | Sensitive | Sensitive |
| CDC 6 | R-H1N1 (S31N) | R H1N1 | Resistant | Resistant |
| CDC 7 | S-H1N1 | S H1N1 | Sensitive | Sensitive |
| CDC 8 | R-H1N1 (S31N) | R H1N1 | Resistant | Resistant |
| CDC 9 | R-H3N2 (V27A) | R H3N2 | Resistant | Resistant |
| CDC 10 | R-H3N2 (S31N) | R H3N2 | Resistant | Resistant |
| CDC 11 | R-H3N2 (S31N) | R H1N1 | Resistant | Resistant |
| CDC 12 | R-H3N2 (S31N) | R H3N2 and R | Resistant | Resistant |
| | | H1N1 | | |
| CU Neg 1 | Negative | Negative | Negative | Negative |
| CU Neg 2 | Negative | Negative | Negative | Negative |

TABLE 6
Summary of results to identify the CDC 12 AVR samples.

| | | | Part II: Subtype | | |
|---|---|---|---|---|---|
| | Part I: Drug | | and Mutation ID | | |
| Sample | Susceptibility | | | Resistant | |
| ID | Sensitive/Resistant | Correct | Subtype | Position | Correct |
| CDC 1 | Sensitive | Yes | H1N1 | — | Yes |
| CDC 2 | Sensitive | Yes | H3N2 | — | Yes |
| CDC 3 | Resistant | Yes | H3N2 | V27A | Yes |
| CDC 4 | Resistant | Yes | H3N2 | S31N | Yes |
| CDC 5 | Sensitive | Yes | H3N2 | — | Yes |
| CDC 6 | Resistant | Yes | H1N1 | S31N | Yes |
| CDC 7 | Sensitive | Yes | H1N1 | — | Yes |
| CDC 8 | Resistant | Yes | H1N1 | S31N | Yes |
| CDC 9 | Resistant | Yes | H3N2 | V27A | Yes |
| CDC 10 | Resistant | Yes | H3N2 | S31N | Yes |
| CDC 11 | Resistant | Yes | H3N2 | S31N | Yes |
| CDC 12 | Resistant | Yes | H3N2 | S31N | Yes |

All of the COMPOSITIONS, METHODS and APPARATUS disclosed and claimed herein can be made and executed without undue experimentation in light of the present disclosure. While the compositions, methods and apparatus have been described in terms of preferred embodiments, it will be apparent to those of skill in the art that variations may be applied to the COMPOSITIONS, METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. An array comprising:
a plurality of capture probes comprising oligonucleotides, wherein the capture probes are capable of binding to oligonucleotides comprising at least a portion of a nucleic acid sequence or complimentary nucleic acid sequence of a target gene of one or more antiviral agent resistant or antiviral agent sensitive virus and wherein the target gene is capable of conferring antiviral agent resistance or antiviral agent sensitivity to the virus.

2. The array of claim 1, wherein the virus is a pathogenic virus.

3. The array of claim 2, wherein the virus is influenza A virus.

4. The array of claim 1, wherein the capture probes are capable of binding to one or more influenza A subtype or strain.

5. The array of claim 1, wherein the plurality of capture probes are bound to the surface of a solid substrate.

6. The array of claim 5, wherein the array contains 200 or less capture probes bound to the surface of the solid substrate.

7. The array of claim 5, wherein the solid substrate is selected from the group consisting of glass, plastic, silicon-coated substrate, macromolecule-coated substrate, particles, beads, microparticles, microbeads, dipstick, magnetic beads, paramagnetic beads and a combination thereof.

8. The array of claim 5, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

9. The array of claim 1, wherein the array is a microarray.

10. The array of claim 9, wherein the microarray is a multiplex characteristic array derived from more than one target gene.

11. The array of claim 1, wherein the capture probes are capable of binding to an influenza strain selected from the group consisting of influenza A H3N2, influenza A H1N1, influenza A H5N1, influenza A H7N7, influenza A H9N2, influenza A H1N2, influenza A H3N8, other
Influenza A, H, and N subtypes, influenza B types, and influenza C types.

12. The array of claim 1, wherein the oligonucleotides comprising at least a portion of a nucleic acid sequence or complimentary nucleic acid sequence are derived from a single target gene segment.

13. The array of claim 1, wherein the capture probes are capable of binding to one or more matrix gene segment (M segment) of influenza virus.

14. The array of claim 1, wherein the capture probes are selected from sequences listed in Table 3.

15. The array of claim 1, wherein each of the capture probes are independently about 10 to about 50 nucleotides (nt) in length.

16. The array of claim 1, wherein the capture probes are designed to distinguish between antiviral sensitive and antiviral resistant strains of influenza A.

17. The array of claim 1, wherein the antiviral agent is selected from the group consisting of adamantane inhibitors; amantadine and rimantadine, and neuraminidase inhibitors; zanamivir, peramivir, the prodrug oseltamivir, prodrug A-315675, T-705, flutimide and a combination thereof.

18. A method for producing an array for detecting the presence of an antiviral agent resistant or antiviral agent sensitive influenza virus comprising:
attaching a plurality of capture probes to a solid substrate surface to form an array, wherein the capture probes are capable of binding to oligonucleotides comprising at least a portion of a nucleic acid sequence or complimentary nucleic acid sequence of a target gene of one or more antiviral agent resistant or antiviral agent sensitive virus and wherein the target gene is capable of conferring antiviral agent resistance or antiviral agent sensitivity to the virus.

19. The method of claim 18, further comprising binding a positive control probe to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

20. The method of claim 18, wherein the capture probes are capable of binding to oligonucleotides comprising at least a portion of a nucleic acid sequence or complimentary nucleic acid sequence of a target gene selected from the group consisting of hemagglutinin (HA gene segment), neuraminidase (NA gene segment), matrix protein (M gene segment), M1, M2, PB1, PB2, PA, NP, NS1, NS2 and a combination thereof.

21. The method of claim 18, wherein the capture probes are capable of binding to oligonucleotides comprising at least a portion of a nucleic acid sequence or complimentary nucleic acid sequence of an M gene segment.

22. The method of claim 18, wherein the antiviral agent is selected from the group consisting of adamantane inhibitors; amantadine and rimantadine, and neuraminidase inhibitors; zanamivir, peramivir, the prodrug oseltamivir, prodrug A-315675, T-705, flutimide and a combination thereof.

23. A method for detecting an antiviral agent resistant or antiviral agent sensitive influenza virus in a sample comprising:
a) contacting the sample with an array of a plurality of capture probes to produce a test array, wherein the test array comprises a capture probe-sample complex when the sample contains an oligonucleotide comprising at least a portion of a nucleic acid sequence or complimentary nucleic acid sequence of a target gene capable of conferring antiviral agent resistance or antiviral agent sensitivity to the influenza virus; and
b) contacting the test array with one or more detection probes to produce a labeled array, wherein the labeled array comprises a target-probe complex when the test array comprises the capture probe-sample complex, and wherein the presence of the target-probe complex is indicative of the presence of antiviral agent resistant or antiviral agent sensitive influenza virus in the sample.

24. The method of claim 23, wherein the array comprises a plurality of capture probes comprising at least a portion of a nucleic acid sequence or complimentary nucleic acid sequence of one or more target genes of at least one antiviral agent resistant or antiviral agent sensitive influenza virus type, subtype or strain.

25. The method of claim 23, wherein the presence of antiviral agent resistant or antiviral agent sensitive influenza virus in the sample is determined by detecting a signal generated by the probe of a target-probe complex.

26. The method of claim 25, wherein the signal generated by the target-probe complex produces different patterns depending on the antiviral agent sensitivity or antiviral agent resistance of the influenza type, subtype or strain present in the sample.

27. The method of claim 23, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.

28. The method of claim 23, further comprising a negative control probe bound to the surface of the solid substrate, wherein the negative control probe is capable of indicating conditions sufficient to indicate specificity of the capture label probes to bind to influenza virus and not to the negative control probe.

29. The method of claim 23, further comprising identifying a target gene wherein identifying the target gene comprises comparing oligonucleotide mismatches of an antiviral agent sensitive to an antiviral agent resistant virus.

30. The method of claim 23, wherein the target gene is selected from the group consisting of hemagglutinin (HA gene segment), neuraminidase (NA gene segment), matrix protein (M gene segment), M1, M2, PB1, PB2, PA, NP, NS1, NS2 and a combination thereof.

31. The method of claim 23, wherein the sample is selected from the group consisting of nasopharangeal washes, expectorate, optical swab, respiratory tract swabs, throat swabs, nasal swabs, nasal mucus, tracheal aspirates, bronchoalveolar lavage, mucus, blood, urine, tissue, saliva, air samples, air-filter samples, surface-associated samples and a combination thereof.

32. The method of claim 23, further comprising obtaining results for sensitivity or resistance to an antiviral agent of the virus in 11 hours or less.

33. The method of claim 23, wherein the capture probes bind to a single target gene and the regions of the single gene selected for binding are from 75 contiguous nucleotides or less of the single gene.

34. A kit comprising:
(a) an array of a plurality of capture probes bound to the surface of a solid substrate, wherein the capture probes are capable of binding to oligonucleotides comprising at least a portion of a nucleic acid sequence or complimentary nucleic acid sequence of a target gene of one or more antiviral agent resistant or antiviral agent sensitive virus and wherein the target gene is capable of conferring antiviral agent resistance or antiviral agent sensitivity to the virus; and
(b) one or more tagged label probes wherein the tagged label probes are capable of producing a signal and wherein the label probes are capable of binding to the oligonucleotides comprising at least a portion of a nucleic acid sequence or complimentary nucleic acid sequence of a target gene of one or more antiviral agent resistant or antiviral agent sensitive influenza virus.

35. The kit of claim 34, further comprising a positive control probe bound to the surface of the solid substrate, wherein the positive control probe is capable of indicating conditions sufficient to form a complex of a capture probe binding to an oligonucleotide comprising at least a portion of a nucleic acid sequence or complimentary nucleic acid sequence of a target gene.
